(19) United States
(12) Patent Application Publication
(10) Pub. No.: US 2015/0145367 A1
(43) Pub. Date: May 28, 2015

(54) PERMANENT MAGNET ROTOR

(71) Applicant: Johnson Electric S.A., Murten (CH)

(72) Inventors: Yue LI, Hong Kong (CN); Chui You ZHOU, Hong Kong (CN); Jie CHAI, Hong Kong (CN); Kwong Yip POON, Hong Kong (CN); San Yuan XIAO, Hong Kong (CN); Han HE, Hong Kong (CN)

(21) Appl. No.: 14/556,009

(22) Filed: Nov. 28, 2014

(30) Foreign Application Priority Data
Nov. 28, 2013 (CN) 201310627892.3

(51) Int. Cl. H02K 1/27; H02K 21/14

(52) U.S. Cl. CPC H02K 1/2706; H02K 21/14
USPC 310/156.08

(57) ABSTRACT

A rotor for a brushless motor includes a shaft, a rotor core and a number of permanent magnets. The rotor core includes inner and outer annular portions. The inner annular portion has a central hole for receiving the shaft. The outer annular portion includes a number of sector segments arranged in a ring, with adjacent sector segments defining a slot there between for receiving a corresponding permanent magnet. Radially outer ends of adjacent sector segments are interconnected by a connector. The sector segments include first sector segments and second sector segments arranged alternately. The first sector segments are separated from the inner annular portion. The second sector segments are each connected to the inner annular portion by connecting arms.

### CROSS REFERENCE TO RELATED APPLICATIONS

This non-provisional patent application claims priority under 35 U.S.C. §119(a) from Patent Application No. 201310627892.3 filed in The People's Republic of China on Nov. 28, 2013, the entire contents of which are hereby incorporated by reference.

### FIELD OF THE INVENTION

This invention relates to a brushless electric motor and in particular, to a permanent magnet rotor for a brushless motor, being of the internal permanent magnet (IPM) type.

### BACKGROUND OF THE INVENTION

Brushless motors include a rotor generally having a shaft, a rotor core fixed to the shaft, and permanent magnets fixed to the rotor core. In an IPM type rotor, the magnets are embedded in the rotor core rather than being fixed to the outer surface of the rotor core. The core of the IPM rotor includes an inner annular portion and an outer annular portion. The inner annular portion has a central through hole for mounting the shaft. The outer annular portion includes a plurality of sector segments arranged in a ring. Each sector segment is connected to the inner annular portion by a bridge. Each permanent magnet is positioned between two corresponding neighboring the sector segments.

However, the above brushless motor suffers from significant magnetic leakage, which affects the performance of the motor.

### SUMMARY OF THE INVENTION

Thus there is a desire for an IPM rotor for a brushless motor having reduced magnetic leakage.

Accordingly, in one aspect thereof, the present invention provides a rotor for an electric motor, comprising: a shaft; a rotor core fixed to the shaft; and a plurality of permanent magnets fixed to the rotor core, wherein the rotor core comprises: an inner annular portion defining a central hole for receiving the shaft; and an outer annular portion comprising a plurality of sector segments arranged in a ring, the sector segments comprising a plurality of first sector segments and a plurality of second sector segments, inner radial ends of the first sector segments being separated from the inner annular portion, inner radial ends of the second sector segments being connected to the inner annular portion by respective connecting arms, and adjacent sector segments define a magnet mounting position there between in which the permanent magnets are disposed.

Preferably, at least a portion of each connecting arm being skewed relative to the radial direction of the rotor core.

Preferably, each connecting arm is straight.

Alternatively, each connecting arm may be curve-shaped.

Preferably, the rotor core comprises a plurality of laminations stacked together, and each first sector segment defines a through hole for insertion of a fastener.

Preferably, a plurality of compressed elastic members are positioned between inner radial ends of the permanent magnets and the inner annular portion of the rotor core.

Preferably, the first sector segments and the second sector segments are alternately arranged in the circumferential direction of the rotor core, the permanent magnets are embedded in the rotor core and extend in the radial and axial directions of the rotor core, with each permanent magnet positioned between adjacent first and second sector segments.

Preferably, a plurality of elastic members are provided, each having two lateral edges abutting against inner radial ends of two permanent magnets positioned on opposite sides of a corresponding first sector segment, the elastic members having a W shape cross section.

Preferably, the first sector segments and the second sector segments are alternately arranged in the circumferential direction of the rotor core, and an outer radial end of each first sector segment connects to an outer radial end of at least one adjacent second sector segment by a connector.

Preferably, a radial thickness of each connector gradually decreases in directions away from the adjacent sector segments which results in the rotor having a gradually reduced outer diameter at each connector.

Preferably, the central hole of the inner annular portion is a stepped hole.

Preferably, the rotor core comprises a plurality of laminations stacked together, and each lamination is a single piece stamped metal piece.

According to a second aspect, the present invention provides a rotor for an electric motor, comprising: a shaft; a plurality of permanent magnets; and a rotor core fixed to the shaft, the rotor core comprising: an inner annular portion defining a central hole for receiving the shaft; and an outer annular portion comprising a plurality of sector segments arranged in a ring, wherein the sector segments comprise a plurality of first sector segments and a plurality of second sector segments arranged alternately, adjacent sector segments defining a slot there between for accommodating the magnets, inner radial ends of the first sector segments being separated from the inner annular portion, and inner radial ends of the second sector segments being connected to the inner annular portion by respective connecting arms; each permanent magnet is respectively disposed in a corresponding one of the slots and extend in radial and axial directions of the rotor core; and a plurality of elastic members compressively positioned between inner radial ends of the permanent magnets and the inner annular portion of the rotor core.

Preferably, each elastic member has two lateral edges abutting against the radially inner ends of two permanent magnets positioned on opposite sides of a corresponding first sector segment, and each elastic member has a W shape cross section.

According to another aspect, the present invention provides an electric motor incorporating the rotor described above. Preferably, the motor is a brushless electric motor comprising: a stator comprising a stator core and end caps mounted to respective ends of the stator core, the stator core having an annular portion and a plurality of teeth extending inwardly and radially from the annular portion. The shaft of the rotor is mounted to the end caps by bearings.

In the embodiments of the present invention, the number of the connecting arms for connecting the sector segments and the inner annular portion is reduced and, therefore, the motor magnetic leakage is reduced and the motor performance is enhanced.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIGS. 1 is a schematic representation of a brushless electric motor in accordance with a preferred embodiment of the present invention, showing a stator core and a rotor core;

FIG. 2 is a view from above of the stator core of FIG. 1;

FIG. 3 shows the rotor core of FIG. 1;

FIG. 4 is a view from above of the rotor core of FIG. 1; and

FIG. 5 is a view from above of a modified rotor core according to a second preferred embodiment.

### DETAILED DESCRIPTION OF THE PREFERRED EMBODIMENTS

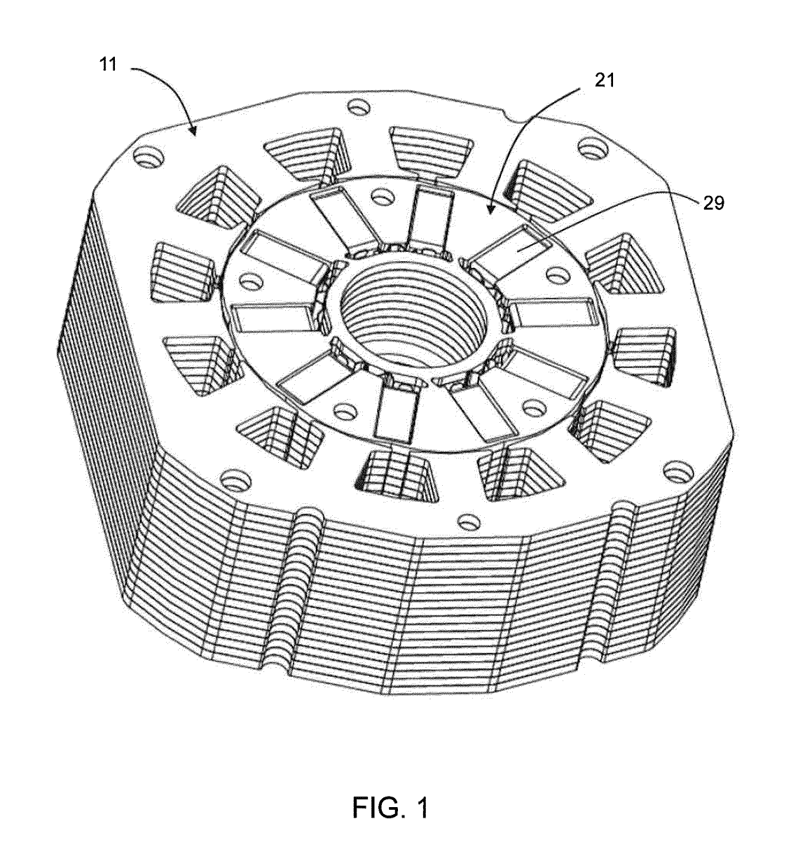

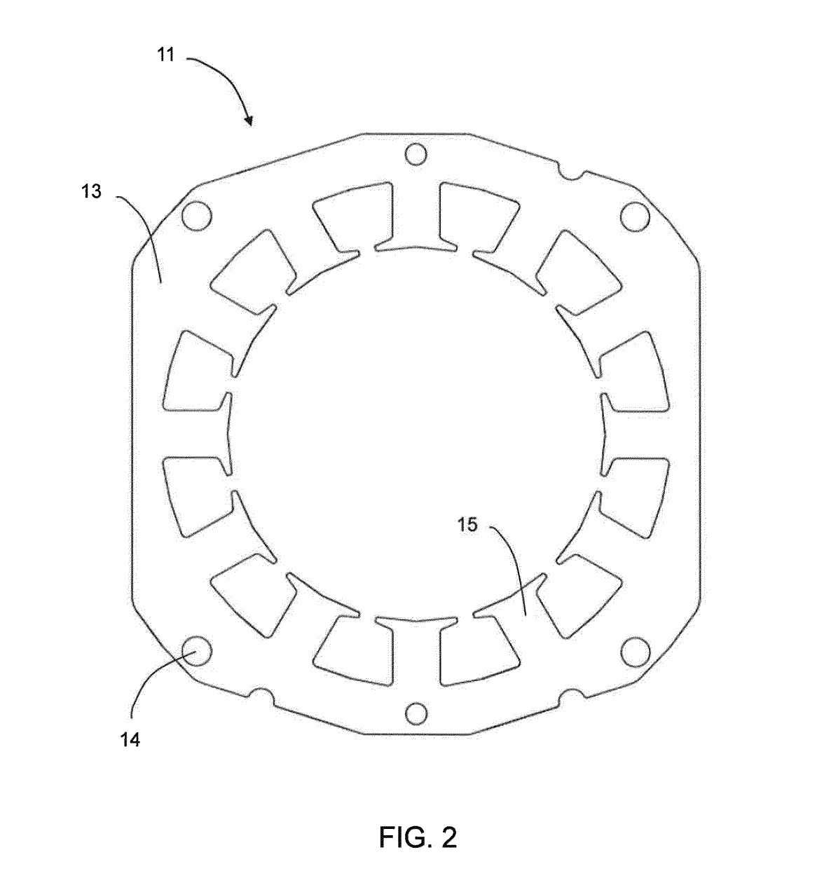

Referring to FIGS. 1 and 2, a brushless direct current motor in accordance with one embodiment of the present invention includes a stator and a rotor. The stator includes a stator core 11, having an annular ring or yoke 13 from which teeth 15 extend radially inward. A winding (not shown) is wound about the teeth 15 of the stator core 11, and end caps (not shown) are mounted to ends of the stator core 11. The end caps support bearings for mounting the shaft. Holes 14 extend through the yoke 13 and may be used for fixing the end caps or for mounting the motor.

The rotor includes a shaft (not shown), a rotor core 21 fixed to the shaft, and a plurality of permanent magnets 29 embedded in the rotor core 21. The shaft of the rotor is mounted to the end caps via bearings (not shown) and thereby is rotatably connected with the stator.

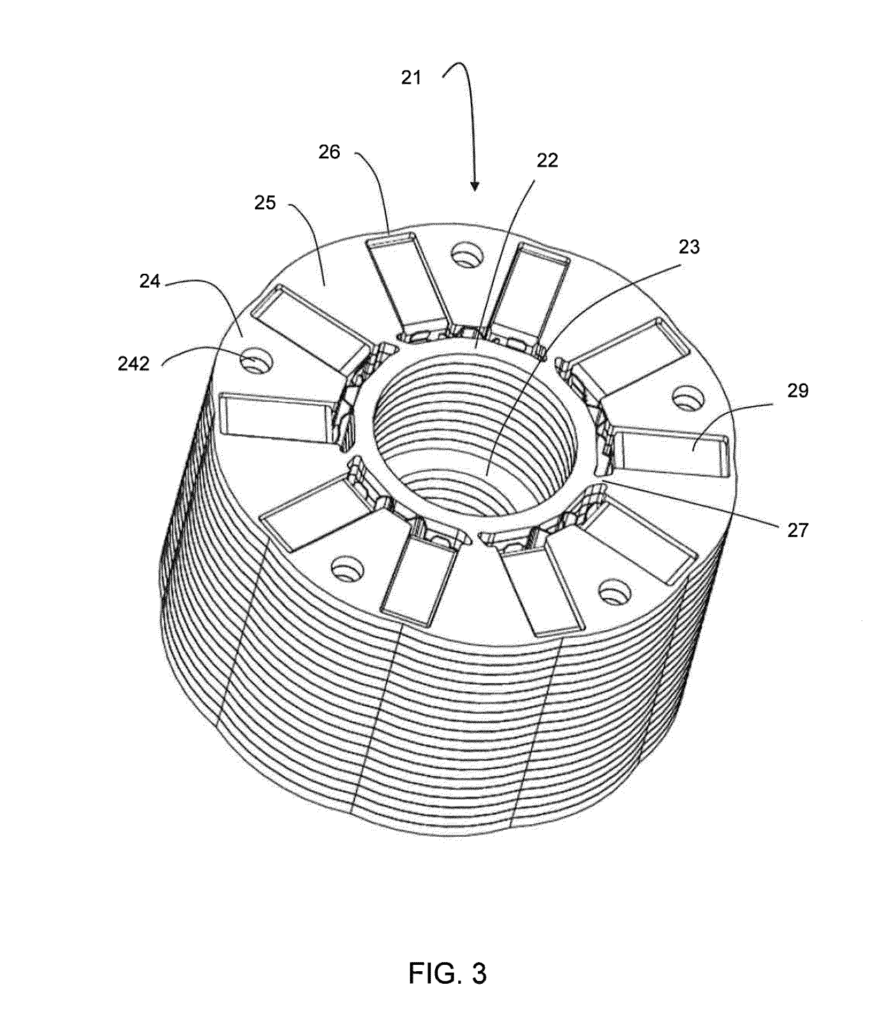

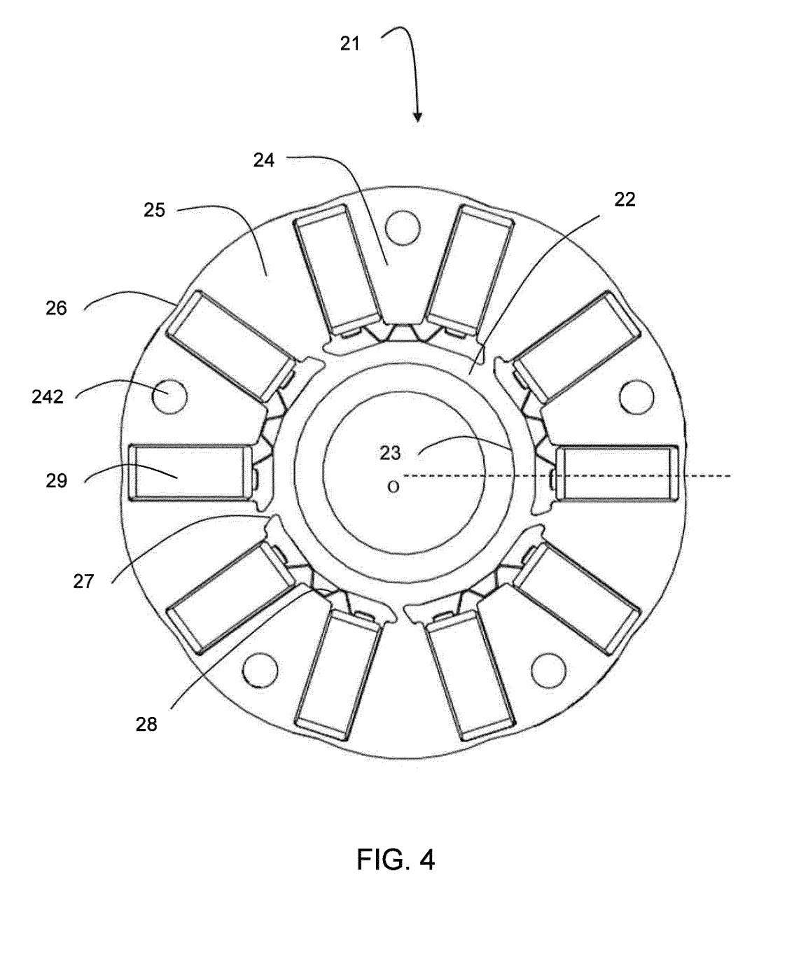

As shown more clearly in FIGS. 3 and 4, the rotor core 21 includes an inner annular portion 22 and an outer annular portion (not labeled). The inner annular portion 23 has a central hole (not labeled) for engagingly receiving the shaft. In the present embodiment, the central hole is a stepped hole, with a step portion 23 formed therein. A bearing for supporting the shaft may be received in the enlarged portion of the central hole. This reduces the axial length of the motor. The outer diameter of the bearing is smaller than the inner diameter of the large-hole-diameter end of the center hole. Therefore, interference between the bearing and the rotor core 21 is avoided.

The outer annular portion includes a plurality of sector segments arranged in a ring. A mounting position (receiving slot) for mounting a permanent magnet 29 is formed between adjacent sector segments. Outer radial ends of adjacent sector segments are connected by a connector 26 extending in a circumferential direction of the rotor. Each connector 26 abuts against an outer radial end of a corresponding permanent magnet 29. Inner radial ends of some of the sector segments are separated from the inner annular portion 22 and such sector segments are termed as first sector segments 24. The inner radial ends of the other sector segments are connected to the inner annular portion 22 through connecting arms 27 and such other sector segments are termed as second sector segments 25. The number of connecting arms 27 for connecting the sector segments and the inner annular portion 22 is reduced compared with the prior art and, therefore, the motor magnetic leakage is reduced and the motor performance is enhanced.

In addition, at least a portion of the connecting arm 27 is skewed relative to the radial direction of the rotor core 21, for reducing vibration and noise. In the present embodiment, each connecting arm 27 is straight, and is angled with respect to the radial direction of the rotor core 21. Preferably, all of the connecting arms 27 have the same angle and skew direction relative to the radial direction of the rotor core 21. It is noted that the connecting arms 27 can be curve-shaped in an alternative embodiment.

In the present embodiment, the first sector segments 24 and the second sector segments 25 are alternately arranged in the circumferential direction of the rotor core 21. Each permanent magnet 29 is embedded between corresponding first and second sector segments 24, 25. The outer radial end of each first sector segment 24 is connected to the outer radial ends of two adjacent second sector segments 25 by respective connectors 26.

In addition, a plurality of elastic members 28 is compressively positioned between the inner radial ends of the permanent magnets 29 and the inner annular portion 22. With the use of the compressed elastic member 28, glue for securing the permanent magnets 29 can be omitted and the assembly of the motor is simplified, which thus enhances the manufacturing efficiency of the motor.

In the present embodiment, the elastic member 28 is a plate-shaped or flake-shaped spring. A cross section of the elastic member 28 (as shown in FIG. 4) shows the elastic member to have a W shape. The elastic member 28 extends in the axial direction of the motor and has two opposite lateral edges abutting against the inner radial ends of two adjacent permanent magnets 29 on opposite sides of a corresponding first sector segment 24. A center section of the elastic member 28 between the two ends thereof is compressed between the inner annular portion 22 and the corresponding first sector segment 24.

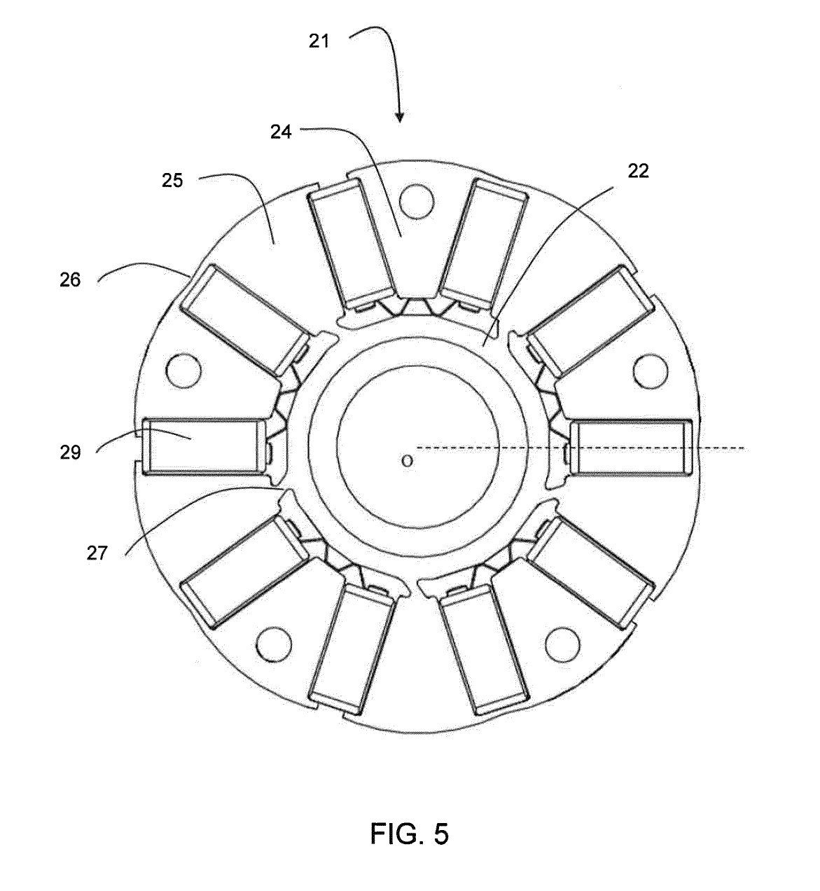

In addition, a radial thickness of each connector 26 gradually decreases in a direction away from the second sector segment 25. That is, the rotor core 21 has a minimum outer diameter at the center of the connector 26. Such configuration is beneficial for further reducing magnetic leakage. To reduce the magnetic leakage still further, each first sector segment 24 can be connected to only one of the adjacent second sector segments 25 by the connector 26. In other words, half of the connectors 26 are broken apart at the center thereof, as shown in FIG. 5. Preferably, the broken connectors 26 and the unbroken connectors 26 are alternately arranged. The slots corresponding to the broken connectors are open slots, while the slots corresponding to the unbroken connectors are closed slots.

In the present embodiment, each permanent magnet 29 is polarized in the circumferential direction of the rotor, and adjacent permanent magnets 29 are polarized in opposite directions, such that the opposing surfaces of the two adjacent permanent magnets 29 are both S polarity, or are both N polarity. Preferably, a center line of the receiving slot for receiving the permanent magnet 29 passes through the center O of the rotor core 21. As such, a center line of each permanent magnet 29 extending in the radial direction and perpendicular to a thickness direction of the permanent magnet 29 passes through the center O of the rotor core 21. Here, the thickness direction of the permanent magnet 29 refers to the polarity direction of the permanent magnet 29.

In the present embodiment, the rotor core 21 comprises a plurality of laminations stacked together in the axial direction of the rotor. Each first sector segment 24 defines a through hole 242 therein, for insertion of a fastener such as a pin there through to fix the laminations together.

Each lamination of the rotor core 21 is integrally formed as a single piece, such as being formed from a sheet material by a punching process. That is, the inner annular portion 22, the first and second sector segments 24, 25, the connector 26 and the connecting arms 27 are integrally formed as a single piece.

In the present embodiment, the rotor has 10 permanent magnets 29, and the stator has 12 teeth 15. Thus, the brushless motor provides 10 magnetic poles and 12 slots. A motor having 10 magnetic poles and 12 slots is particularly suitable for use in compressors of refrigerators and air conditioners.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A rotor for an electric motor, comprising:
a shaft;
a rotor core fixed to the shaft; and
a plurality of permanent magnets fixed to the rotor core,
wherein the rotor core comprises: an inner annular portion defining a central hole for receiving the shaft; and
an outer annular portion comprising a plurality of sector segments arranged in a ring, the sector segments comprising a plurality of first sector segments and a plurality of second sector segments, inner radial ends of the first sector segments being separated from the inner annular portion, inner radial ends of the second sector segments being connected to the inner annular portion by respective connecting arms, and
adjacent sector segments define a magnet mounting position there between in which the permanent magnets are disposed.

2. The rotor of claim 1, wherein at least a portion of each connecting arm being skewed relative to the radial direction of the rotor core.

3. The rotor of claim 1, wherein each connecting arm is straight.

4. The rotor of claim 1, wherein each connecting arm is curve-shaped.

5. The rotor of claim 1, wherein the rotor core comprises a plurality of laminations stacked together, and each first sector segment defines a through hole for insertion of a fastener.

6. The rotor of claim 1, wherein a plurality of compressed elastic members are positioned between inner radial ends of the permanent magnets and the inner annular portion of the rotor core.

7. The rotor of claim 1, wherein the first sector segments and the second sector segments are alternately arranged in the circumferential direction of the rotor core, the permanent magnets are embedded in the rotor core and extend in the radial and axial directions of the rotor core, with each permanent magnet positioned between adjacent first and second sector segments.

8. The rotor of claim 7 further comprising a plurality of elastic members each having two lateral edges abutting against inner radial ends of two permanent magnets positioned on opposite sides of a corresponding first sector segment, the elastic members having a W shape cross section.

9. The rotor of claim 1, wherein the first sector segments and the second sector segments are alternately arranged in the circumferential direction of the rotor core, and an outer radial end of each first sector segment connects to an outer radial end of at least one adjacent second sector segment by a connector.

10. The rotor of claim 9, wherein a radial thickness of each connector gradually decreases in directions away from the adjacent sector segments which results in the rotor having a gradually reduced outer diameter at each connector.

11. The rotor of claim 1, wherein the central hole of the inner annular portion is a stepped hole.

12. The rotor of claim 1, wherein the rotor core comprises a plurality of laminations stacked together, and each lamination is a single piece stamped metal piece.

13. A rotor for an electric motor, comprising:
a shaft;
a plurality of permanent magnets; and
a rotor core fixed to the shaft, the rotor core comprising: an inner annular portion defining a central hole for receiving the shaft; and an outer annular portion comprising a plurality of sector segments arranged in a ring,
wherein the sector segments comprise a plurality of first sector segments and a plurality of second sector segments arranged alternately, adjacent sector segments defining a slot there between for accommodating the magnets, inner radial ends of the first sector segments being separated from the inner annular portion, and inner radial ends of the second sector segments being connected to the inner annular portion by respective connecting arms;
each permanent magnet is respectively disposed in a corresponding one of the slots and extend in radial and axial directions of the rotor core; and
a plurality of elastic members compressively positioned between inner radial ends of the permanent magnets and the inner annular portion of the rotor core.

14. The rotor of claim 13, wherein each elastic member has two lateral edges abutting against the radially inner ends of two permanent magnets positioned on opposite sides of a corresponding first sector segment, and each elastic member has a W shape cross section.

15. A brushless electric motor comprising:
a stator comprising a stator core and end caps mounted to respective ends of the stator core, the stator core comprising an annular portion and a plurality of teeth extending inwardly and radially from the annular portion; and
the rotor of claim 1, the shaft of the rotor being mounted to the end caps by bearings.

16. An electric motor incorporating the rotor of claim 13.
